(19) United States
(12) Patent Application Publication
(10) Pub. No.: US 2026/0083057 A1
(43) Pub. Date: Mar. 26, 2026

(54) CROSS TRACK ERROR SENSOR AND RELATED DEVICES, SYSTEMS, AND METHODS

(71) Applicant: Ag Leader Technology, Ames, IA (US)

(72) Inventors: Roger Zielke, Huxley, IA (US); Scott Eichhorn, Ames, IA (US)

(21) Appl. No.: 19/402,732

(22) Filed: Nov. 26, 2025

Related U.S. Application Data
(62) Division of application No. 18/116,714, filed on Mar. 2, 2023.
(60) Provisional application No. 63/315,850, filed on Mar. 2, 2022.

(51) Int. Cl. A01D 41/127; G01D 5/14

(52) U.S. Cl. CPC A01D 41/1278; G01D 5/145

(57) ABSTRACT

A method for determining cross track error, comprising calibrating a stalk sensor with two or more set points, detecting plant stalks by the stalk sensor, measuring a stalk angle for each plant stalk, and measuring presence and amount of cross track error based on the stalk angle.

### CROSS-REFERENCE TO RELATED APPLICATION(S)

This application is a divisional of U.S. patent application Ser. No. 18/116,714, filed Mar. 2, 2023 which claims the benefit under 35 U.S.C. § 119 (e) to U.S. Provisional Application 63/315,850, filed Mar. 2, 2022, and entitled CROSS TRACK ERROR STALK SENSOR, each of which are hereby incorporated herein by reference in its entirety for all purposes.

### TECHNICAL FIELD

The disclosure relates to devices systems and methods for agricultural harvesting and more particularly determining cross track error.

### BACKGROUND

The disclosure relates to cross track error is recognized cause of lost yield and thereby economic harm for farmers and other stakeholders. The ability to determine cross track error and correct cross track error is important to maximizing yields and reducing lost yield.

### BRIEF SUMMARY

In Example 1 a method for determining cross track error, comprising calibrating a stalk sensor with two or more set points, detecting plant stalks by the stalk sensor, measuring a stalk angle for each plant stalk, and measuring presence and amount of cross track error based on the stalk angle.

Example 2 relates to the method of Example 1, further comprising instructing a vehicle guidance system to correct measured cross track error.

Example 3 relates to the method of Example 1, further comprising filtering signals for the stalk sensor to exclude signals not from plant stalks.

Example 4 relates to the method of Example 1, further comprising resetting calibration values for the two or more set point when a stripper plate moves.

Example 5 relates to the method of Example 1, wherein the two or more set point comprise a zero-degree set point and a twenty-five-degree set point.

Example 6 relates to the method of Example 1, wherein when a sensor signal from a left sensor member is greater than a zero-degree set point cross track error to the right is measured.

Example 7 relates to the method of Example 1, wherein when a sensor signal from a right sensor member is greater than a zero-degree set point cross track error to the left is measured.

Example 8 relates to the method of Example 1, wherein when a sensor signal from a left sensor member and a right sensor member are less than a zero-degree set point for the left sensor member and the right sensor member no cross track error is indicated.

Example 9 relates to the method of Example 1, wherein the amount of cross track error is equal to header height multiplied by Tan (stalk angle).

In Example 10 a system for measuring and correcting cross track error comprising a stalk sensor configured to detecting stalk presence and record a series of stalk sensor signals, a database comprising recorded values of two or more set points for the stalk sensor for determining a stalk angle from the series of stalk sensor signals, and a processor in communication with the stalk sensor configured to measure cross track error from the stalk angle, wherein cross track error is equal to a header height multiplied by Tan (stalk angle).

Example 11 relates to the system of Example 10, wherein the stalk sensor is a contact sensor comprising a left sensor member and a right sensor member.

Example 12 relates to the system of Example 11, wherein the two or more set point comprising a zero-degree set point.

Example 13 relates to the system of Example 12, wherein cross track error to the right is indicated then a peak reading from the left sensor member is greater than the zero-degree set point.

Example 14 relates to the system of Example 12, wherein cross track error to the left is indicated then a peak reading from the right sensor member is greater than the zero-degree set point.

Example 15 relates to the system of Example 10, wherein the two or more set point recorded values are determined by measuring signals from the stalk sensor when a jig is held at a known angle within the stalk sensor.

Example 16 relates to the system of Example 10, further comprising a vehicle guidance system wherein the processor is configured to communicate the measured cross track error to the vehicle guidance system and wherein the vehicle guidance system is configured to correct the cross track error.

Example 17 relates to the system of Example 10, wherein the two or more set point recorded values are dependent on a specific gap between stripper plates.

Example 18 relates to the system of Example 10, wherein the stalk sensor is a magnetic, contact stalk sensor.

In Example 19 a method for correcting cross track error of an agricultural vehicle comprising calibrating a stalk sensor with two or more set points, comprising deflecting a left sensor member with a jig at a zero-degree angle and recording the deflection signal value as a first set point for the left sensor member, deflecting a left sensor member with a jig at an angle greater than zero-degrees and recording the deflection signal value as a second set point for the left sensor member, deflecting a right sensor member with a jig at a zero-degree angle and recording the deflection signal value as a first set point for the right sensor member, deflecting a left sensor member with a jig at an angle greater than zero-degrees and recording the deflection signal value as a second set point for the right sensor member, and creating a stalk angle curve for the left sensor member and the right sensor member from the first and second set points of the left sensor member and the right sensor member. The method also comprising measuring a series of sensor deflection signals during operation of the agricultural vehicle, determining a peak sensor deflection signal during a stalk event, determining a stalk angle from the peak sensor deflection signal and the stalk angle curves, comparing the peak sensor deflection signal to the first set point of the left sensor member and the first set point of the right sensor member to detect the presence of cross track error, measuring a magnitude of cross track error by multiplying a header height by Tan (stalk angle), and steering the agricultural vehicle, automatically, to correct the cross track error.

Example 20 relates to the method of Example 19, further comprising filtering and excluding sensor deflection signals not indicative of a stalk event.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a schematic overview of a harvester implementing the system, according to one implementation.

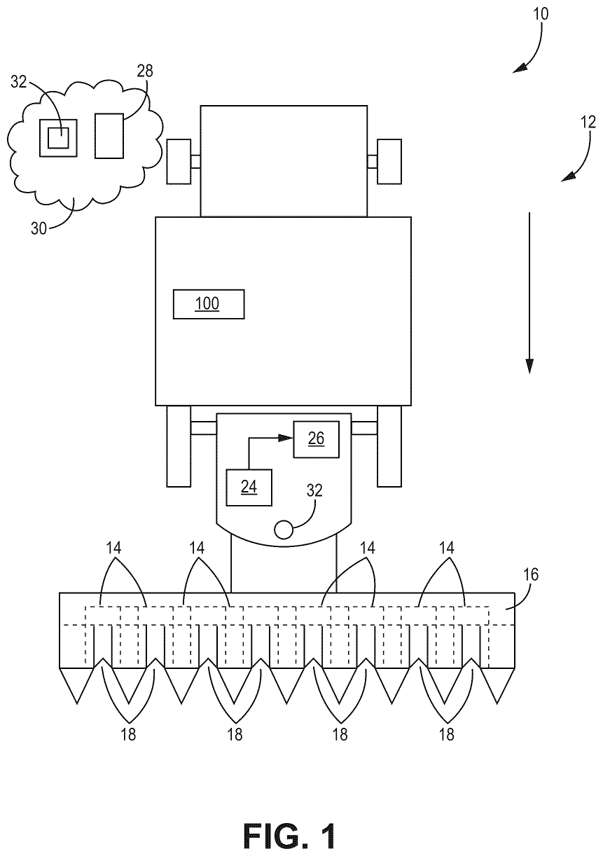

FIG. 2 is a perspective view of a stalk sensor disposed on a row unit, according to one implementation.

FIG. 3 is a flow diagram of the system, according to one implementation.

FIG. 4 is a top, perspective view of jig calibration of a stalk sensor, according to one implementation.

FIG. 5 is a top, perspective view of a jig calibration of a stalk sensor, according to one implementation.

FIG. 6 is a front view of a stalk sensor during jig calibration, according to one implementation.

FIG. 7 is a front view of a stalk sensor during jig calibration, according to one implementation.

FIG. 8 is an exemplary stalk angle curve for a stalk sensor, according to one implementation.

FIG. 9 is an exploded view of a stripper plate spacing sensor, according to one implementation.

FIG. 10 is an exemplary graphical view of a time-series of stalk sensor signals, according to one implementation.

FIG. 11 is a flow diagram of exemplary logic for determining cross track error, according to one implementation.

FIG. 12 is a front view a stalk sensor measuring cross track error, according to one implementation.

FIG. 13 is a top view of a harvester and exemplary mapping of a heading, according to one implementation.

FIG. 14 is a top view of a planting implement and exemplary path, according to one implementation.

FIG. 15 is a forward view from a forward-facing visual sensor determining a harvester heading, according to one implementation.

### DETAILED DESCRIPTION

The various devices, systems, and methods described herein relate generally to the use of stalk sensors for calculating and determining cross track error (XTE) therefrom. In various implementations, the system senses stalks and determines a stalk angle relative to the ground which in turn may be used to determined XTE. Once XTE has been determined an automatic or assisted steering system may adjust a harvester heading to eliminate XTE.

Various of the devices and methods herein relate to the devices and methods for elimination/reduction of XTE disclosed in U.S. patent application Ser. No. 16/918,300, which is incorporated by reference herein. Additionally, various stalk sensors may be implemented with the devices, systems, and methods disclosed herein. As has been previously described, stalk sensors can be mounted on a row crop harvester to simultaneously count stalks and determine cross track error (XTE).

The stalk sensors may include, for example, a hall effect magnetic sensor, for detecting and measuring stalks. A hall effect magnetic sensor may be configured to measure the magnetic field strength of a permanent magnet embedded into a resilient mechanical member, as described in U.S. patent application Ser. No. 17/013,037. As stalks push open the sensor member, the embedded magnet moves closer to a rigidly mounted magnetic sensor. The magnetic field increases as the magnet approaches the sensor and decreases as it moves away. The result being a sensor signal that is proportional and repeatable to the deflection distance of each sensor member.

Turning to the figures in more detail, the system 10 may be implemented on a harvester 12. In various implementations, certain components may be present on the harvest 12 while others may be remote from the harvester 12. Various configurations and locations of components would be recognized by those of skill in the art.

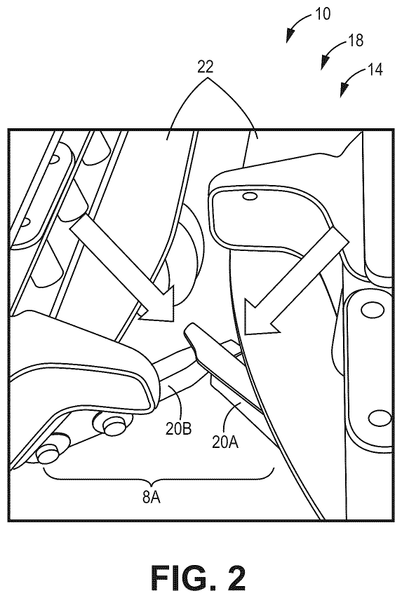

The harvester 12 is configured to harvest row crops through row units 14 disposed on a corn head 16. One or more row unit 14 may include a stalk sensor 18. Shown close up in FIG. 2, the stalk sensor 18 includes one or more sensor members/wands 20. In various implementations, the sensor members 20 are located at the gap between the stripper plates 22, such that the sensor member 20 are deflected as stalks enter the stripper plate 22 gap, as had been previously described.

In various implementations, the stalk sensor 18 is in communication with a display 24 and/or other processor 26, such as the InCommand® display from Ag Leader. The system 10 may also optionally include a storage medium 28 to store data. The storage medium 28 may be located on the harvester 12 or may be remote, such as cloud 30 based storage 28. The storage medium 28 may include transitory and/or permanent storage and may include any software, hardware, or firmware components necessary to execute the steps of the methods, as would be understood.

The system 10 may also be in communication with and operate alongside a vehicle guidance system 100. The vehicle guidance system 100 may be or include an automatic or assisted steering system or device, as would be appreciated. Further implementations of the system 10 include a GPS 32 or other geo-location device 32, as would be understood.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. patent application Ser. No. 16/918,300, filed Jul. 1, 2020, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. patent application Ser. No. 16/997,040, filed Aug. 19, 2020, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. patent application Ser. No. 17/225,740, filed Apr. 8, 2021, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,678, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/081,432, filed Dec. 14, 2022, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,801, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. Patent Application 63/346,665, filed May 27, 2022, entitled “Seed Delivery Tube Camera for Furrow Monitoring,” U.S. Patent Application 63/351,602, filed Jun. 13, 2022, entitled “Apparatus, Systems and Methods for Image Plant Counting,” U.S. Patent Application 63/357,082, filed Jun. 30, 2022, entitled “Seed Tube Guard,” U.S. Patent Application 63/357,284, filed Jun. 30, 2022, entitled “Grain Cart Bin Level Sharing,” U.S. Patent Application 63/394,843, filed Aug. 3, 2022, entitled “Hydraulic Cylinder Position Control for Lifting and Lowering Towed Implements,” U.S. Patent Application 63/395,061, filed Aug. 4, 2022, entitled “Seed Placement in Furrow,” U.S. Patent Application 63/400,943, filed Aug. 25, 2022, entitled “Combine Yield Monitor,” U.S. Patent Application 63/406,151, filed Sep. 13, 2022, entitled “Hopper Lid with Magnet Retention and Related Systems and Methods,” U.S. Patent Application 63/427,028, filed Nov. 21, 2022, entitled “Stalk Sensors and Associated Devices, Systems and Methods,” U.S. Patent Application 63/445,960, filed Feb. 15, 2023, entitled “Ear Shelling Detection and Related Devices, Systems, and Methods,” and U.S. Patent Application 63/445,550, filed Feb. 14, 2023, entitled “Liquid Flow Meter and Flow Balancer,” each of which is incorporated herein by reference.

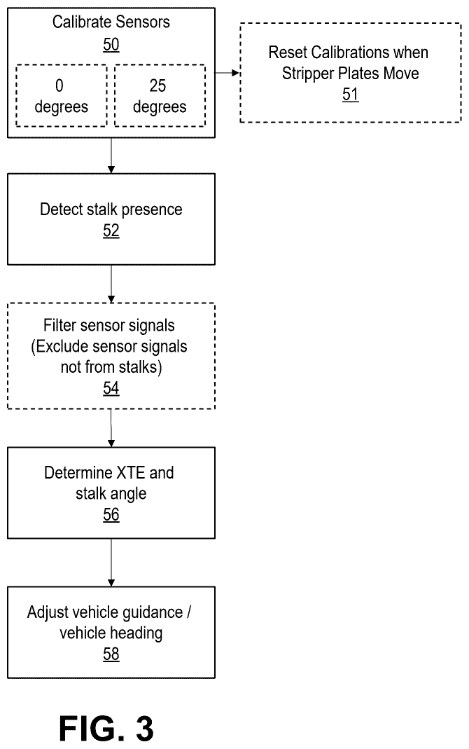

The devices, systems, and methods disclosed herein calculate XTE by measuring the stalk angle as stalks pass through the stalk sensor 18, including left sensor member 20A and right sensor member 20B. Turning to FIG. 3, generally, the system 10 is configured execute a series of steps, each of which is optional and may be performed in any order or not at all. Various steps may be performed intermittently, iteratively, and/or at any time. In one step, the system 10 calibrates the stalk sensors 18 and sensor members 20A, 20B (box 50). In another optional step, the system 10 may then detect the presence of stalks (box 52). Optionally, the system 10 may be configured to filter and/or exclude certain sensor signals from the data set (box 54). In a further optional step, the system 10 determines XTE and stalk angle form the sensor signals (box 56). In another optional step, the system 10 may command or be in communication with an automatic/assisted steering system 100 to adjust harvester 12 heading.

The devices, system, and methods disclosed herein may be implemented with any stalk sensor 18 that can measure stalk angle. Exemplary stalk sensors 18 include, but are not limited to, magnetic resistive sensors, mechanical strain sensors, ultrasonic sensors, and light-based sensors.

### Stalk Sensor Calibration (Box 50)

As has been previously described, stalk sensors 18 may be calibrated to have a set point or threshold deflection that marks when the sensor member has deflected to a point even with the edge of the stripper plate 22. That is, if the threshold deflection is exceeded the sensor member 20A, 20B has deflected past the edge of the stripper plate 22.

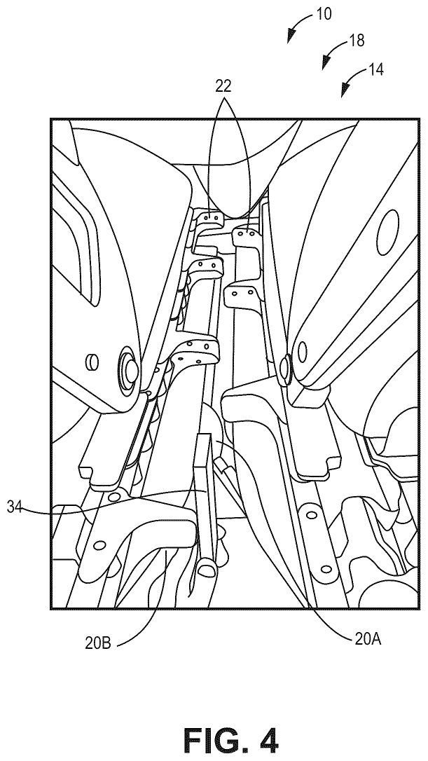

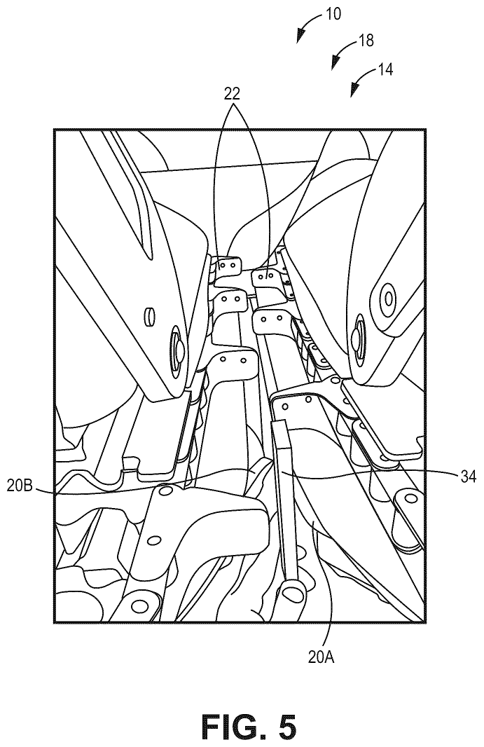

Turning to FIGS. 4 and 5, left and right sensor member 20A, 20B set point calibrations can be determined such as by using a jig 34 to hold deflect each sensor member 20A, 20B back to the point where it is even with the edge of the stripper plate 22. The set point(s) can be used to calculate sensor readings and convert those readings into stalk angles. In the example of FIGS. 4 and 5, the jig 34 is held perpendicular to the ground while deflecting the sensor members 20A, 20B. In these and other implementations, the set points are recorded in the memory or storage device 28 either local to the harvester 12 such as a storage medium 28 integrated with the display 24, or alternative may be stored in cloud 30 based storage.

In various implementations, the left and right sensor members 20A, 20B each require at least two set point calibrations. As would be appreciated more than two set point calibrations may be performed and recorded. For example, more than two set points may be necessary for non-linear sensors 18. In experimental data, magnetic sensors 18 have shown a near linear output between a zero degree and twenty-five-degree stalk angles. The subsequent examples use these two set point calibration values, but alternative calibration values are possible and would be understood by those of skill in the art.

FIGS. 4 and 5 are examples of a zero-degree, with respect to vertical, calibration/set point determination. A vertical jig 34 deflects the sensor member 20A, 20B when the jig 34 is held against the edge of each stripper plate 22. The system 10 records a zero-degree sensor reading while the jig 34 is held in place.

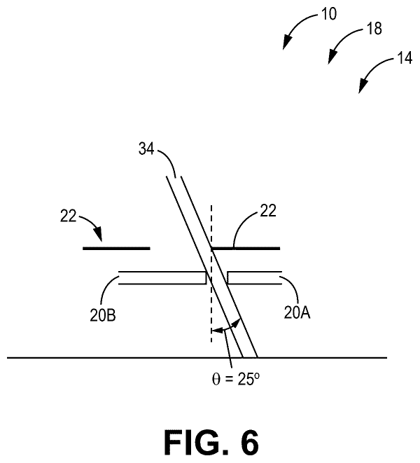

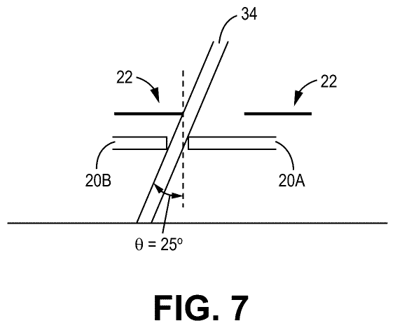

Similarly, a twenty-five-degree, with respect to vertical, jig 34 deflects the sensor member 20A, 20B as the jig 34 is held against the edge of each stripper plate 22 and is at a twenty-five degree angle with respect to the ground, as shown for example in FIGS. 6 and 7. The jig 34 creates the twenty-five-degree theta (e) angle relative to the ground. The system 10 records a twenty-five-degree sensor reading while the jig 34 is held in place. Example calibration numbers are shown in Table 1 below. Of course alternative calibration numbers and angles are possible and would be appreciated by those of skill in the art.

TABLE 1

| Jig Stalk | Left Sensor | Right Sensor |
|---|---|---|
| Angle | (20A) | (20B) |
| (degrees) | Reading | Reading |
| 0 | 185 | 226 |
| 25 | 260 | 310 |

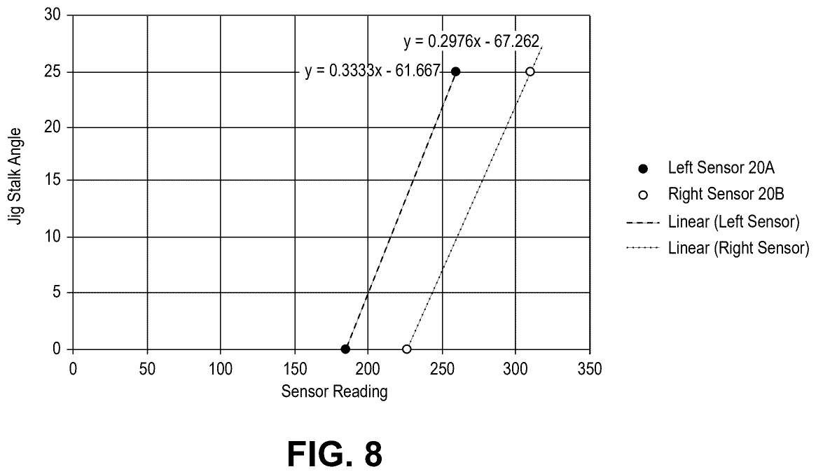

In various implementations, the set points (for example the zero- and twenty-five-degree set points) are used to create a linear curve/calibration for each sensor member 20A, 20B, shown for example in FIG. 8. A unique calibration curve is generated for each sensor 18 and sensor member 20A, 20B. As would be understood sensor 18 installation and inherent differences in the sensors 18/sensor member 20A, 20B themselves can be a cause for difference between individual components such that individual calibration is necessary.

Stalk angle calibration values are unique to the left/right position of the stripper plates 22 relative to the sensor members 20A, 20B. As would be understood, stripper plates 22 can be adjusted left or right to provide a wider or narrower stripper plate gap. As would be appreciated, the harvester operator can adjust stripper plates 22 on-the-go on many modern corn heads 16. Adjustment on older corn heads 16 often requires wrenches and the harvester 12 to be shutoff. Further, most modern corn heads 16 are configured to move only one side of the stripper plates 22, while the other side stripper plate 22 is fixed. The adjustable stripper plates 22 are usually mechanically linked together so that one actuator moves all rows at the same time to the same width.

In various implementations, the set points/calibrations are reset for each time a stripper plate moves (box 51 of FIG. 3). As would be appreciated, in certain situations, such as when the stripper plates 22 move a small amount, the system 10 may perform with enough accuracy to not require the set points/calibrations to be reset despite movement of the stripper plates 22. Yet, it would also be understood that accuracy and precision of the system 10 is increased when the set points/calibrations are changed along with the stripper plate 22 positions.

As an example, the XTE error is about 2 inches for every 3/16 inch the stripper plate 22 moves from its calibrated location. Harvester 12 steering systems 100 may become too slow or too fast to respond when XTE error is 2+ inches.

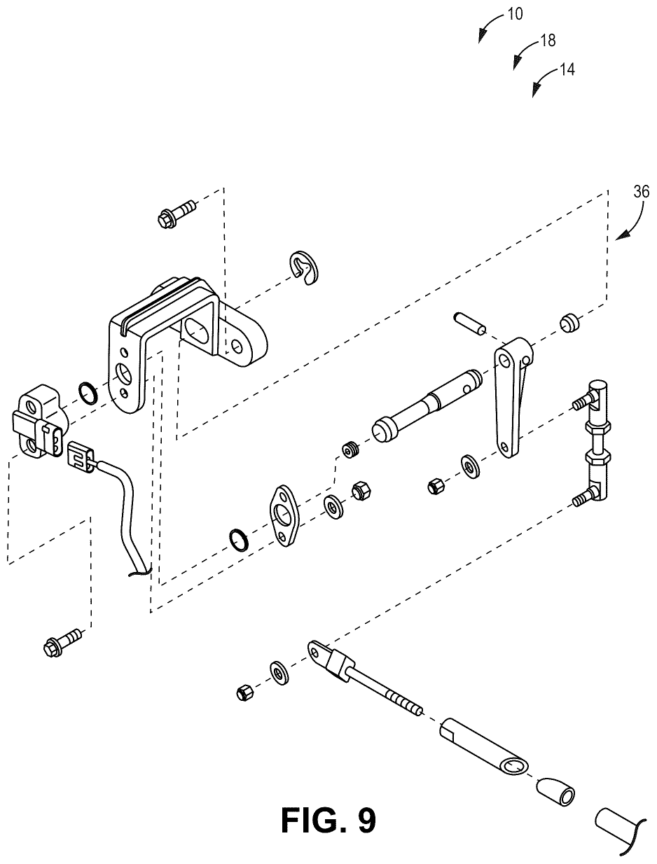

It is burdensome for the harvester operator that frequently adjusts stripper plates 22 to stop after each adjustment and redo the jig 34 calibration, described above. Therefore, the system 10 may employ a stripper plate 22 spacing sensor 36 (shown for example in FIG. 9) to automatically adjust the jig 34 calibration numbers as the stripper plates 22 are adjusted. In various implementations, the spacing sensor 36 measures the distance the stripper plate 22 moves left and right and based on prior jig 34 calibrations and sensor 18 characteristics, the system 10 automatically calculates new jig 34 calibrations in proportion to the stripper plate 22 sensor 36 signal change.

### Stalk Angle Calculation (Boxes 52-56)

In various implementations, the system 10 excludes and or filters sensor 18 signals (box 54). For example sensor 18 signals not indictive of stalk presence may be excluded from the time series of stalk sensor 18 signals.

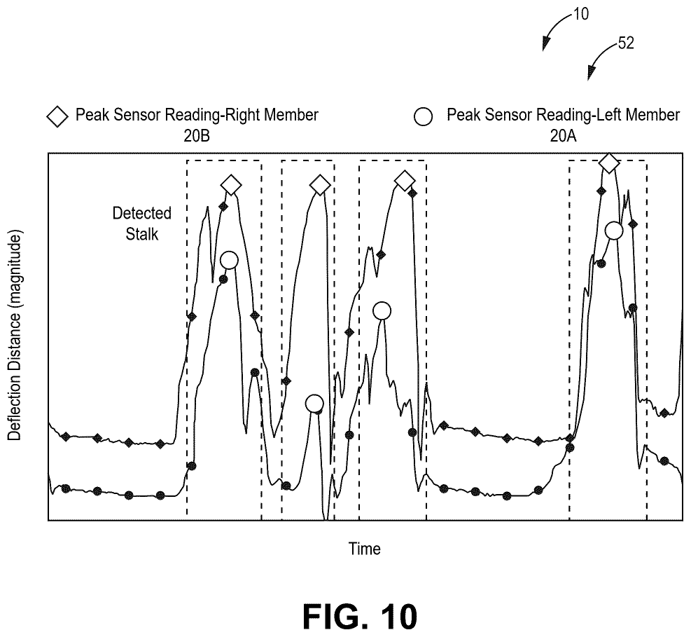

In one specific example the system 10 excludes sensor signals 18 between stalks in order to calculate stalk angle accurately. For example, sometimes weeds and/or corn stalk leaves can appear between stalks, moving the sensor members 20A, 20B, and thereby creating noise that should be eliminated prior to analysis/executing further steps of the method. In various implementations, a stalk detection algorithm is employed to determine a “stalk pulse” or signal indicative of a stalk passing through the sensor (box 52), as shown in FIG. 10. In these implementations, within each stalk pulse, a left and right peak sensor reading is measured.

As would be understood, corn stalks are elliptical, and therefore will continue to push or deflect the sensor member 20A, 20B open until the sensor member 20A, 20B has reached the round extent of the stalk. This spot corresponds to the peak reading within the stalk pulse. Various alternative measures that are proportional to peak value may be employed instead of peak value, in alternative implementations. For example, when analyzing the population of all deflection data collected during a detected stalk event—the stalk pulse—Root Mean Square (RMS) or the 3rd quartile value could be used (box 52).

Additionally, in some implementations the time-series of stalk sensor 18 deflection data could be filtered before identifying a peak value (box 54). Such methods include low pass, band pass, FIR, and IIR recursive filters, among others that would be known and appreciated by those of skill in the art. Data outlier rejection techniques such as local outlier factor, Z-score, isolation forest, autoencoders, or other methods may be used before selecting a peak value in order to reduce noise (box 54).

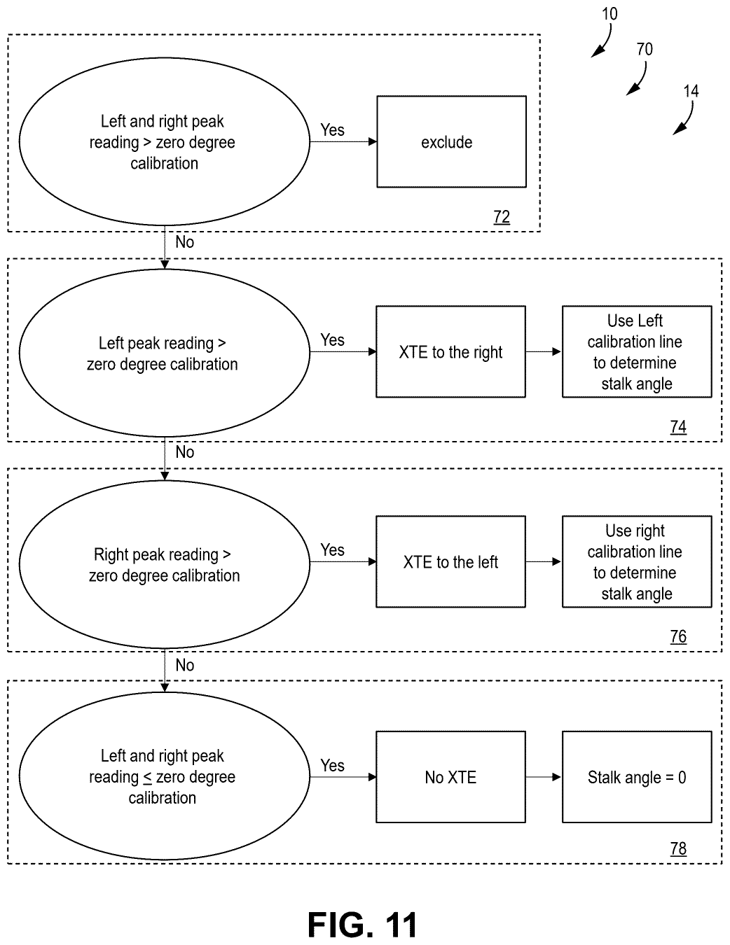

In various implementations, the system 10 uses logic 70 to calculate stalk angle from peak sensor readings. An exemplary logic path 70 is outlined below and is shown in FIG. 11. Various alternative algorithms and/or logic trees may be used and would be appreciated from this disclosure. In various implementations, the logic 70 is executed by the processor 26 or any other appropriate hardware, software, and/or firmware as would be appreciated.

In one optional step, if the left and right sensor peak reading are both greater than their respective zero-degree jig calibration numbers, the signal is ignored/skipped/excluded (box 72). This signal may optionally be excluded because it is likely that a large clump of crop material or an ear is passing through the sensor member 20A, 20B rather than a stalk. Because it is not a stalk passing through the sensor 18 a stalk angle reading derived from that signal would be incorrect.

### Example

$$Left Sensor ( 20 A ) Peak Reading = 203$$

$$Right Sensor ( 20 B ) Peak Reading = 274$$

$$Left zero - degree jig calibration = 185$$

$$Right zero - degree jig calibration = 260$$

203 is greater than 185 and 274 is greater than 260; therefore, the peak/signal is ignored.

In a further optional step, if the left sensor 20A peak reading is greater than the left zero-degree jig calibration number, the system 10 recognizes the harvester 12 is steering off to the right of the row (right XTE) (box 74). In this condition the system 10 is configured to use the left sensor calibration line to calculate stalk angle.

### Example

$$Left Sensor ( 20 A ) Peak Reading = 234$$

$$Right Sensor ( 20 B ) Peak Reading = 218$$

$$Left zero - degree jig calibration = 185$$

$$Right zero - degree jig calibration = 260$$

$$Left Sensor Calibration Line = Stalk Angle = 0.3333 ( Left Sensor Peak Reading ) - 61.667 . y = 0.3333 x - 61.667 ( see Figure 2 )$$

$$Stalk angle = 16.3 degrees = 0.3333 ( 234 ) - 61.667$$

In a still further optional step, if the right sensor 20B peak reading is greater than the right zero-degree jig calibration number, the system 10 recognizes the harvester 12 is steering off to the left of the row (box 76). In this condition, the system 10 is configured to use the right sensor calibration line to calculate stalk angle.

### Example

$$Left Sensor Peak Reading = 160$$

$$Right Sensor Peak Reading = 304$$

$$Left zero - degree jig calibration = 185$$

$$Right zero - degree jig calibration = 260$$

$$Right Sensor Calibration Line = Stalk Angle = 0.2976 ( Right Sensor Peak Reading ) - 67.262 . y = 0.2976 x - 67.262 ( see Figure 2. )$$

$$Stalk angle = 23.2 degrees = 0.2976 ( 304 ) - 67.262$$

If a still further optional step, if the left 20A and right 20B sensor peak readings are both be equal to or less than their zero-degree jig calibration numbers, the system 10 recognizes the stalks as entering vertically through the stripper plate 22 gap, which indicates the harvester 12 is aligned with the row (no XTE) and the stalk angle is set to zero (box 78).

By the use of the peak reading to determine if there is XTE and the stalk angle, the determination is not influenced by stalk size, travel speed, or plant population.

### XTE Calculation (Box 56)

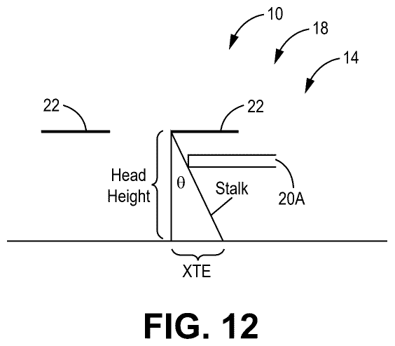

In various implementations, the system 10 uses the geometry illustrated in FIG. 12 to calculate XTE from the stalk angle. In FIG. 12 the stalk angle is theta (e) and XTE is calculated according to the following formula:

$$Header Height * Tan θ = XTE$$

As would be appreciated, various prior known XTE measuring systems indicate left and right by negative and positive values—a left XTE is negative and a right XTE is positive. For example, four inches off to the left of the row is shown as [−4] XTE and four inches off to the right is [4] XTE. The current system determines XTE direction (left or right) as described in the steps above—by comparing sensor 18 signals to set points.

### Right XTE Example

$$Head Height = 12 inches$$

$$Stalk Angle = 16.3$$

$$XTE sign = [ + ]$$

$$12 * Tan ( 16.3 ) = 3.5$$

$$XTE = [ 3.5 ] Inches$$

### Left XTE Example

$$Head Height = 12 inches$$

$$Stalk Angle = 23.2$$

$$XTE sign = [ - ]$$

$$12 * Tan ( 23.2 ) = 5.1$$

$$XTE = [ - 5.1 ] inches$$

As would be appreciated and as has been previously described, header 12 height can be changed manually or automatically on-the-go. Various automatic systems can maintain a header 12 height set by the harvester operator; however, the operator may change target height to accommodate changes in stalk conditions, such as lodged stalks. Further, steering systems 100 may perform adequately if the actual head height stays within ±2-3 inches of the XTE system setting. A difference greater than ±2-3 inches from the XTE system setting can create a high XTE error that may degrade steering performance. Because of this, the system 10 may employ a header height sensor (in lieu of or in addition to a user setting), such as is described in U.S. patent application Ser. No. 17/576,463, which has been incorporated herein by reference.

### Heading Error Calculation and Correction (Box 58)

In various implementations, the system 10 may be configured to communicate with a vehicle guidance system 100. As would be understood, vehicle guidance systems 100 may realize a performance benefit from receiving information on the deviation between the actual vehicle heading and the desired path heading, herein referred to as heading error. In various implementations, heading error may be provided in addition to XTE but is not a requirement for vehicle guidance. During harvest the exact, ideal path of the combine is unknown which complicates calculating a heading error.

In certain implementations, the vehicle guidance system 100 can estimate the current path by shifting the path traveled during the harvester's 12 previous path by the swath width of the working head. In many cases this will provide a good estimate of the path, though path features unique to the current path, such as obstacles or hazards, will not be reflected in the estimate. Various vehicle guidance methods have been previously described and certain of those are disclosed in U.S. patent application Ser. No. 16/939,785, which has been incorporated herein by reference.

In alternative implementations, the current path may be estimated from the path travelled by the planting implement or tractor attached to the planting implement when it planted the crop now being harvested. If the planter and combine do not use the same swath or working width, a new harvest path may be generated based on the neighboring planting paths.

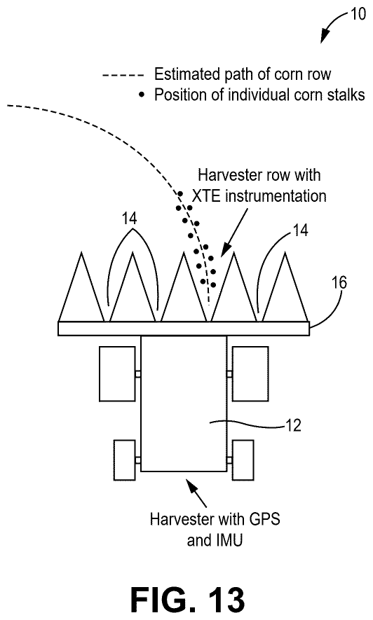

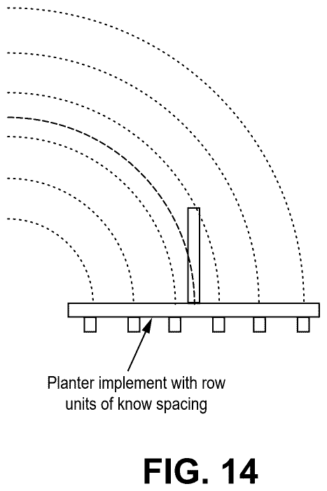

In a further alternative implementation, the current path may be estimated by fitting a line, spline, arc, circle, polynomial curve of any order, conic section, or other geometric path to the recently reported absolute ground positions of plant stalks in each row. With an absolute harvester 12 position and heading established by the GPS 32 and IMU of the guidance system 100 and the position relative to the harvester 12 of a plant stalk from the XTE measurement method described above, it is possible to calculate the absolute ground position of the measured stalk. The path fitting may be done using a variety of methods, including least squares fit, hyper circle fitter, or others as shown in FIG. 13. It should be noted that when a towed or mounted rigid-toolbar planter navigates a turn, the planter inscribes a family of arcs, with each row unit following its own unique radius, as shown in FIG. 14. Therefore, the estimated path for each measured row may be calculated individually then evaluated as a group to determine the harvester 12 path.

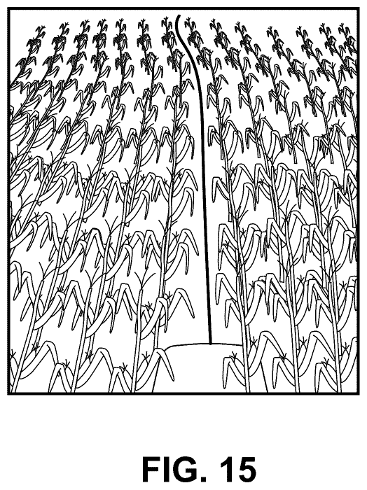

The heading error may be estimated by using non-contact sensing of crop rows ahead of the harvester. Sensing could be performed using video cameras, Lidar, stereo video, radar, or other methods as shown for example in FIG. 15.

Contact XTE measurements, as described herein, can provide a more precise indication of XTE when operating in fully grown corn that is ready to harvest. Optionally, in combination with the various heading error measurements/algorithms, the XTE measurements can be used to correct harvester heading and direct an automatic steering system 100 to eliminate/reduce XTE and thereby maximize yield.

In certain implementations, the system 10 utilizes artificial intelligence to dynamically update the defined thresholds/set points and other established processes described herein. Machine learning algorithms are trained on historical data to analyze patterns and identify correlations between input parameters and system performance. These algorithms are then used to continuously monitor the system and make adjustments to the various thresholds and parameters in real-time. Certain implementations utilize a combination of rule-based and machine learning approaches, where a set of predefined rules are used to adjust the thresholds in specific situations, while machine learning algorithms are used to optimize the thresholds in other scenarios. Additionally, the system can also be configured to receive feedback from users and use this feedback to make further adjustments to the thresholds. This allows for a more adaptive and responsive system that can continuously improve its performance over time.

Although the disclosure has been described with references to various embodiments, persons skilled in the art will recognize that changes may be made in form and detail without departing from the spirit and scope of this disclosure.

What is claimed is:

1. A system for measuring and correcting cross track error comprising:
(a) a stalk sensor configured to detecting stalk presence and record a series of stalk sensor signals;
(b) a database comprising recorded values of two or more set points for the stalk sensor for determining a stalk angle from the series of stalk sensor signals; and
(c) a processor in communication with the stalk sensor configured to measure cross track error from the stalk angle,
wherein cross track error is equal to a header height multiplied by the stalk angle.

2. The system of claim 1, wherein the stalk sensor is a contact sensor comprising a left sensor member and a right sensor member.

3. The system of claim 2, wherein the two or more set point comprising a zero-degree set point.

4. The system of claim 3, wherein cross track error to the right is indicated then a peak reading from the left sensor member is greater than the zero-degree set point.

5. The system of claim 3, wherein cross track error to the left is indicated then a peak reading from the right sensor member is greater than the zero-degree set point.

6. The system of claim 1, wherein the two or more set point recorded values are determined by measuring signals from the stalk sensor when a jig is held at a known angle within the stalk sensor.

7. The system of claim 1, further comprising a vehicle guidance system wherein the processor is configured to communicate the measured cross track error to the vehicle guidance system and wherein the vehicle guidance system is configured to correct the cross track error.

8. The system of claim 1, wherein the two or more set point recorded values are dependent on a specific gap between stripper plates.

9. The system of claim 1, wherein the stalk sensor is a magnetic, contact stalk sensor.

10. A system for measuring and correcting cross track error, comprising:
(a) a stalk sensor comprising one or more wands extending into a stripper plate gap and having two or more set points, the stalk sensor configured to detect stalks and generate a series of stalk signals;
(b) a processor in communication with the stalk sensor and configured to processes the series of stalk signals to determine a stalk angle for each detected stalk from peak signals from the series of stalk signals and the two or more set points, and wherein the processor is configured to determine a presence and an amount of cross track error from the stalk angle.

11. The system of claim 10, further comprising a vehicle guidance system configured to receive commands to correct cross track error.

12. The system of claim 10, wherein the processor is further configured to filter the series of stalk signals to exclude signals not from plant stalks.

13. The system of claim 10, wherein the stalk sensor is a contact sensor comprising a left sensor member and a right sensor member.

14. The system of claim 13, wherein the two or more set points comprise at least a zero-degree set point.

15. The system of claim 14, wherein when a sensor signal from the left sensor member is greater than the zero-degree set point cross track error to the right is detected.

16. The system of claim 14, wherein when a sensor signal from the right sensor member is greater than the zero-degree set point cross track error to the left is detected.

17. The system of claim 14, wherein when a sensor signal from the left sensor member and the right sensor member are less than the zero-degree set point for the left sensor member and the right sensor member no cross track error is indicated.

18. The method of claim 1, wherein the amount of cross track error is equal to header height multiplied by the stalk angle.

19. A system for measuring and correcting cross track error of an agricultural vehicle comprising:
(a) a stalk sensor calibrated with at least a zero-degree set point and a greater than zero-degree set point for each sensor member, the stalk sensor configured to measure a series of sensor deflection signals;
(b) a memory configured to store the zero-degree set point deflection value, the greater than zero-degree set point deflection value for each sensor member, and a stalk angle curve for each sensor member from the zero-degree set point deflection value, and the greater than zero-degree set point deflection value;
(c) a processor in communication with the stalk sensor and the memory, the processor configured to determine a peak sensor deflection signal during a stalk event, determine a stalk angle from the stalk angle curve for each sensor member, and determine a presence and amount of cross track error from the stalk angle; and
(d) a vehicle guidance system in communication with the processor and configured to receive correct present cross track error.

20. The system of claim 19, wherein the processor is further configured to filter and exclude sensor deflection signals not indicative of a stalk event.
